(19) United States
(12) Patent Application Publication
(10) Pub. No.: US 2011/0222603 A1
(43) Pub. Date: Sep. 15, 2011

(54) Method and System Making It Possible to Protect A Compressed Video Stream Against Errors Arising During a Transmission

(75) Inventors: Cédric Le Barz, Limours En Hurepoix (FR); Marc Leny, Nanterre (FR); Didier Nicholson, Asnieres sur Seine (FR)

(73) Assignee: THALES, Neuilly-sur-Seine (FR)

(21) Appl. No.: 12/996,254

(22) PCT Filed: Jun. 3, 2009
(86) PCT No.: PCT/EP2009/056829

§ 371 Date: May 2, 2011

(30) Foreign Application Priority Data
Jun. 3, 2008 (FR) 0803064

(51) Int. Cl. H04N 5/217

(52) U.S. Cl. 375/240.16; 375/E07.104

(57) ABSTRACT

A method is provided for protecting a compressed video stream that may be decomposed into a foreground plane composed of objects of a first type and a background plane composed of objects of a second type against errors during the transmission of this stream on an unreliable link, characterized in that it comprises at least the following steps: a) analyzing the stream in the compressed domain so as to define various image areas in which redundancy will be added, the motion estimation vectors and the transformed coefficients obtained in the compressed domain are transmitted to the redundancy addition step; b) adding redundancy to the objects of said areas determined in the previous step, a), while taking account of the motion estimation vectors and of the transformed coefficients obtained in the compressed domain; c) transmitting the set of areas forming the image.

The invention relates to a method and a system making it possible to transmit a video stream while integrating redundancy so as to resist transmission errors, doing so on an already compressed video stream. The invention is applied for example at the output of a video coder.

The invention is used to transmit compressed video streams in any transmission context liable to encounter errors. It is applied in the field of telecommunications.

Hereinafter in the document, the expression “transmission context” is used to designate unreliable transmission links, that is to say a means of transmission on which an error-sensitive communication is carried out.

Likewise, the term “foreground plane” designates the mobile object or objects in a video sequence, for example, a pedestrian, a vehicle, a molecule in medical imaging. On the contrary, the designation “background plane” is used with reference to the environment as well as to fixed objects. This comprises, for example, the ground, buildings, trees which are not perfectly stationary or else parked cars.

The invention can, inter alia, be applied in applications implementing the standard defined in common by the MPEG ISO and the video coding group of the ITU-T termed H.264 or MPEG-4 AVC (advanced video coding) and SVC (scalable video coding) which is a video standard providing a more effective compression than the previous video standards while exhibiting a complexity of implementation which is reasonable and oriented toward network applications.

In the description, the expression “compressed video stream” and the expression “compressed video sequence” designate a video.

The concept of Network Abstraction Layer, better known by the abbreviation NAL used in the subsequent description, exists in the H.264 standard. It involves a network transport unit which can contain either a slice for the VCL (Video Coding Layer) NALs, or a data packet (suites of parameters—SPS (Sequence Parameters Set), PPS (Picture Parameter Set)—, user data, etc.) for the NON-VCL NALs.

The expression “slice” or “portion” corresponds to a sub-part of the image consisting of macroblocks which belong to one and the same set defined by the user. These terms are well known to the person skilled in the art in the field of compression, for example, in the MPEG standards.

Currently, certain transmission networks used in the field of telecommunications do not offer reliable communications insofar as the signal transmitted may be marred by numerous transmission errors. During the transmission of compressed video sequences, the errors may turn out to be very penalizing.

The type of errors encountered during transmission and during the stream decoding step may correspond to errors introduced by a transmission channel, such as the family of wireless channels, civilian conventional channels for example transmission on UMTS, WiFi, WiMAX, or else military channels. These errors may be a “loss of packets” (loss of a string of bits or bytes), “bit errors” (possible inversion of one or more bits or bytes, randomly or in bursts) or “erasures” (loss of size or position, known, of one or more or of a string of bits or bytes) or else result from a mixture of these various incidents.

The prior art describes various schemes making it possible to combat transmission errors.

For example, before coding the images, it is known to add information to the video data provided by the video coder, doing so before transmission. This technique does not however take account of problems of compatibility with the stream decoder.

One technique uses the ARQ packet retransmission mechanism, the abbreviation standing for “Automatic Repeat Request”, which consists in repeating the erroneous packets. This transmission on a second channel or second stream, although turning out to be efficacious, exhibits the drawback by general opinion of being sensitive to the lag in a transmission network. It is not truly suitable in certain services which require real-time constraints.

Another technique consists in using an error-correcting coder which adds redundancy to the data to be transmitted.

Patent application FR 2 854 755 also describes a method for protecting a stream of compressed video images against the errors which occur during the transmission of this stream. This method consists in adding redundancy bits over the whole set of images and transmitting these bits with the compressed video images. Though it turns out to be effective, this method exhibits the drawback of increasing the transmission time. Indeed, the redundancy is added without making any distinction on the images transmitted, that is to say the addition of redundancy is performed on a large number of images.

One of the objects of the present invention is to offer a method of protection against the transmission errors which occur during the transmission of a video stream.

The invention relates to a method for protecting a compressed video stream that may be decomposed into at least one first set composed of objects of a first type and at least one second set composed of objects of a second type, against errors during the transmission of this stream on an unreliable link, characterized in that it comprises at least the following steps:
a) analyzing the stream in the compressed domain so as to identify various areas in which the redundancy will be added, the motion estimation vectors and the transformed coefficients obtained in the compressed domain are transmitted to the redundancy addition step,
b) adding redundancy to the objects of said areas determined in step a), while taking account of the motion estimation vectors and of the transformed coefficients obtained in the compressed domain,
c) transmitting the set of areas forming the image.

For a stream compressed with an H.264 standard, the method comprises in the course of the redundancy addition step at least the following steps:
analyzing the video stream in the compressed domain,
defining at least one first group of objects containing areas of objects or objects to be protected in said stream,
determining, for a given image or a given group of images, a network transport unit of undefined NAL type (described in the standard by the term “undefined NAL”), which will convey the redundancy information,
an image being composed of several blocks, analyzing the blocks of said image or of the group of images in progress,
   i. if the block of the image or of the group of images belongs to the first group, then determining the redundancy data and adding them, accompanied by the coordinates of the block of the image, in the NAL unit determined in the previous step,
   ii. otherwise doing nothing,
transmitting the part of the compressed stream comprising the whole set of original information without particular robustness, as well as the new NAL units transporting the redundancy corresponding to the first group of objects.

The first type of objects corresponds, for example, to a foreground plane comprising mobile objects in an image. In video surveillance applications for example, they will be allocated redundancy since they correspond to the most important part of the video stream.

The method can use a Reed Solomon code to apply the redundancy.

The analysis in the compressed domain, used by the method, determines for example a mask identifying the blocks of the image belonging to the various objects of the scene. Generally, an object will correspond to the background plane. The set of other elements of the mask will be able to be grouped under the same label (in the case of a binary mask) which will then group together all the blocks of the image belonging to the mobile objects or foreground plane.

The method can also use subsequent to the analysis in the compressed domain a function determining the coordinates of encompassing boxes corresponding to the objects belonging to the foreground plane in an image; the coordinates of said encompassing boxes are determined on the basis of the mask.

The image by image “updating” of the slice groups or “SGs” is, for example, accompanied by the transmission of a PPS parameter (the abbreviation standing for Picture Parameters Set) which indicates the new splitting of the image to a decoder.

The invention also relates to a system making it possible to protect a video sequence intended to be transmitted on a very unreliable transmission link, characterized in that it comprises at least one video coder suitable for executing the steps of the method exhibiting at least one of the aforementioned characteristics comprising an on-network video broadcasting system and an associated processing unit.

Other characteristics and advantages of the device according to the invention will be more apparent on reading the description which follows of a wholly nonlimiting illustrative exemplary embodiment together with the figures which represent:

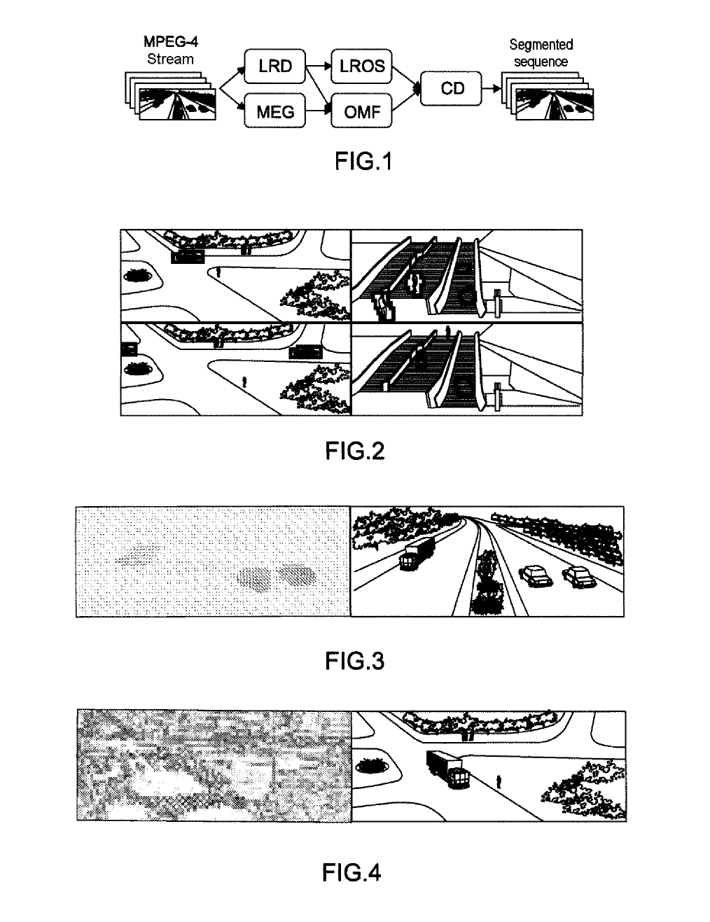

FIGS. 1 to 4, the results obtained by an analysis in the compressed domain,

FIG. 5, an example describing the steps implemented for adding redundancy to a compressed stream, and

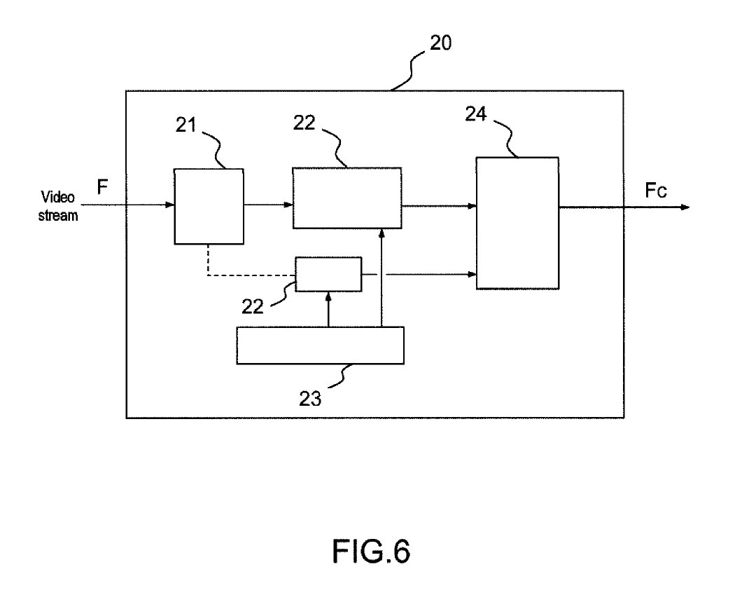

FIG. 6, an exemplary diagram for a video coder according to the invention.

In order to better elucidate the manner of operation of the method according to the invention, the description includes a reminder regarding the way to perform an analysis in the compressed domain, such as it is described, for example, in US patent application 2006 188013 with reference to FIGS. 1, 2, 3 and 4 and also in the following two references:
Leny, Nicholson, Prêteux, “De l'estimation de mouvement pour l'analyse temps réel de vidéos dans le domaine compressé” [Motion estimation for the real-time analysis of videos in the compressed domain], GRETSI, 2007.
Leny, Préteux, Nicholson, “Statistical motion vector analysis for object tracking in compressed video streams”, SPIE Electronic Imaging, San Jose, 2008.

In summary the techniques used inter alia in the MPEG standards and set out in these articles consist in dividing the video compression into two steps. The first step is aimed at compressing a still image. The image is divided into blocks of pixels (of 4×4 or 8×8 depending on the MPEG standards—1/2/4), which subsequently undergo a transform allowing a switch to the frequency domain, and then a quantization makes it possible to approximate or to delete the high frequencies to which the eye is less sensitive. Finally these quantized data are entropically coded. The objective of the second step is to reduce the temporal redundancy. For this purpose, it makes it possible to predict an image on the basis of one or more other images previously decoded within the same sequence (motion prediction). For this purpose, the process searches through these reference images for the block which best corresponds to the desired prediction. Only a vector (Motion Estimation Vector, also known simply as the Motion Vector), corresponding to the displacement of the block between the two images, as well as a residual error making it possible to refine the visual rendition are preserved.

These vectors do not necessarily correspond however to a real motion of an object in the video sequence but can be likened to noise. Various steps are therefore necessary in order to use this information to identify the mobile objects. The works described in the aforementioned publication of Leny et al, “De l'estimation de mouvement pour l'analyse temps réel de vidéos dans le domaine compressé”, and in the aforementioned US patent application have made it possible to delimit five functions rendering the analysis in the compressed domain possible, these functions and the implementation means corresponding thereto being represented in FIG. 1:

1) a Low Resolution Decoder (LRD) makes it possible to reconstruct the entirety of a sequence at the resolution of the block, deleting on this scale the motion prediction;
2) a Motion Estimation vectors Generator (MEG) determines, for its part, vectors for the set of the blocks that the coder has coded in “Intra” mode (within Intra or predicted images);
3) a Low Resolution Object Segmentation (LROS) module relies, for its share, on an estimation of the background plane in the compressed domain by virtue of the sequences reconstructed by the LRD and therefore gives a first estimation of the mobile objects;
4) motion-based filtering of objects (OMF—Object Motion Filtering) uses the vectors output by the MEG to determine the mobile areas on the basis of the motion estimation;
5) finally a Cooperative Decision (CD) module makes it possible to establish the final result on the basis of these two segmentations, taking into account the specifics of each module depending on the type of image analyzed (Intra or predicted).

The main benefit of analysis in the compressed domain pertains to calculation times and memory requirements which are considerably reduced with respect to conventional analysis tools. By relying on the work performed during video compression, analysis times are today from tenfold to twentyfold the real time (250 to 500 images processed per second) for 720×576 4:2:0 images.

One of the drawbacks of analysis in the compressed domain such as described in the aforementioned documents is that the work is performed on the equivalent of low resolution images by manipulating blocks composed of groups of pixels. It follows from this that the image is analyzed with less precision than by implementing the usual algorithms used in the uncompressed domain. Moreover, objects that are too small with respect to the splitting into blocks may go unnoticed.

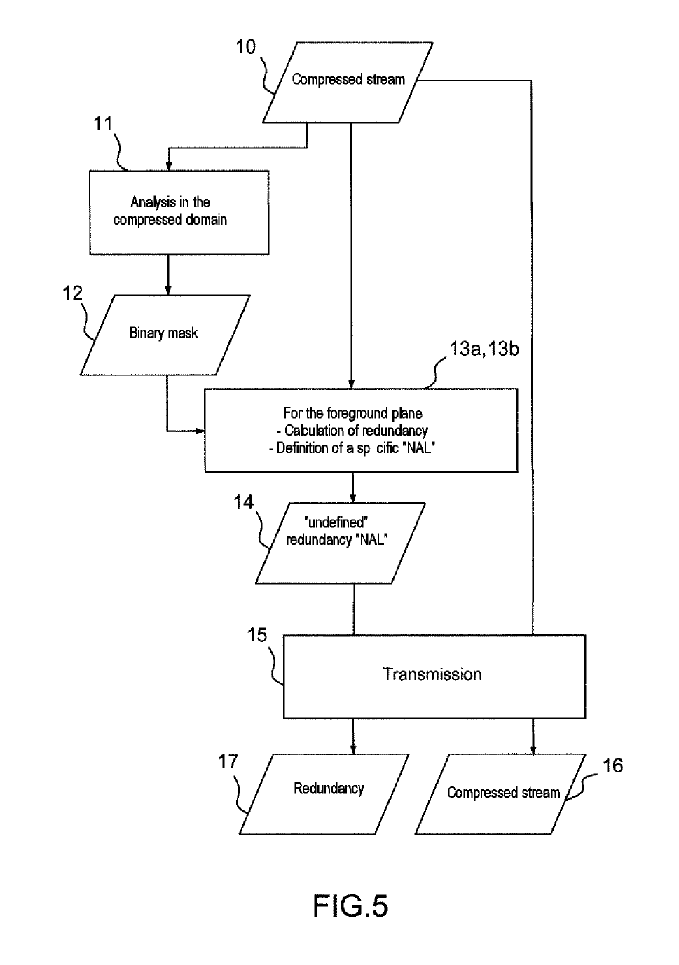

The results obtained by the analysis in the compressed domain are illustrated by FIG. 2 which show the identification of areas containing mobile objects. FIG. 3 shows diagrammatically the extraction of specific data such as the motion estimation vectors and FIG. 4 low resolution confidence maps obtained corresponding to the contours of the image.

FIG. 5 shows diagrammatically an exemplary embodiment of the method according to the invention in which redundancy will be added to chosen areas in the compressed stream. This method is implemented within a video sender comprising at least one video coder and a processing unit shown diagrammatically in FIG. 6. This sender also comprises a channel coder. The areas of greater importance in the stream will be chosen to be protected against transmission errors, if any.

The compressed video stream 10 output by a coder is transmitted to a first analysis step 12, the function of which is to extract the representative data. Thus, the method employs for example a sequence of masks comprising blocks (regions that have received an identical label) linked with the mobile objects. The masks may be binary masks.

This analysis in the compressed domain has made it possible to define for each image or for a defined group of images GoP, on the one hand various areas Z1i belonging to the foreground plane P1 and other areas Z2i belonging to the background plane P2 of a video image. The analysis may be performed by implementing the method described in the aforementioned US patent application. However, any method making it possible to obtain an output of the analysis step taking the form of masks per image, or any other format or parameters associated with the compressed video sequence analyzed, will also be able to be implemented at the output of the step of analysis in the compressed domain. On completion of the analysis step, the method has for example binary masks 12 for each image (block or macroblock resolution). An exemplary convention used may be the following: “1” corresponds to a block of the image belonging to the foreground plane and “0” corresponds to a block of the image belonging to the background plane.

The image by image “updating” of the slice groups or “SGs” is, for example, accompanied by the transmission of a PPS parameter (Picture Parameters Set) which indicates the new splitting of the image to a decoder.

Two apparently independent main steps constitute the present invention: analysis and addition of redundancy. Specifically, these various modules can communicate with one another to optimize the whole of the processing chain:
For the analysis in the compressed domain, it is necessary to de-encapsulate the stream, to shape the data (the parser) and finally to perform an entropy decoding. The motion estimation vectors and the transformed coefficients are thus obtained. These modules are also necessary for the addition of redundancy but will not need to be repeated.
The analysis module which defines the splitting of the image according to the regions of interest dispatches these parameters to the redundancy addition brick, accompanied by the previously obtained data.
For the addition of redundancy properly speaking, once again the transformed coefficients and motion estimation vectors are necessary for defining the redundant part of the stream. The proposed method makes it possible here also to circumvent the de-encapsulation and entropy decoding step since the information travels from module to module.
Once these steps have been processed, only then do the new entropy coding and the encapsulation of the stream with the additional units for error correction take place.

The invention therefore allows more than a simple juxtaposition of functions that process a video stream in series: feedback loops are possible and all the redundant steps between the modules involved are now present only once.

In a more general application framework, it will now be possible to define, not two areas, but rather several types of objects which will give rise to an application of the redundancy as a function of their importance and their sensitivity.

According to an implementation variant as was indicated previously, it is also possible to process the encompassing boxes around the mobile objects. The coordinates of encompassing boxes correspond to the mobile objects and are calculated with the aid of the mask. These boxes may be defined by virtue of two extreme points or else by a central point associated with the dimension of the box. It is possible in this case to have a set of coordinates per image or one for the whole sequence with trajectory information (date and point of entry, curve described, date and point of exit).

The method thereafter selects the blocks or the areas Z1i (slices) of the image comprising these mobile objects (plane P1) and on which redundancy will be added.

An implementation linked with the H.264 standard inserts the redundant part of the code solely for the blocks of the foreground plane P1 into independent “NAL” units or network abstraction layers. The redundancy calculation 13a is done using for example a Reed-Solomon code.

For this exemplary embodiment, the method considers the user data. The method then determines, 13b, NALs of undefined type, of type 30 and 31, inside which it is possible to transmit any type of redundancy information and the indices of the macroblocks for which a redundancy has been calculated. In contradistinction to the other types of NAL, type 30 and type 31, are not reserved, whether for the stream itself or the RTP-RTSP type network protocols. A standard decoder will merely put aside this information whereas a specific decoder, developed to take these NALs into account, will be able to choose to use this information to detect and correct transmission errors, if any.

Specifically, in this exemplary implementation, the addition of redundancy will be done via a loop which is iterated over the blocks of the binary mask. If the block is set to “0” (background plane), we go directly to the next one. If it is set to “1” (foreground plane), a Reed-Solomon code is used to determine the redundancy data, and then the coordinates of this block will be added in a specific NAL, followed by the calculated data. It is possible to transmit one NAL per slice, per image or per group of images GoP (Group of Pictures), depending on the constraints of the application.

The transmission step 15 will take account of the compressed stream which has not been modified and of the stream comprising the areas for which redundancy has been added.

A conventional decoder will therefore consider a normal stream, with no feature of robustness to errors, 16, whereas a suitably adapted decoder will use these new NALs, 17, containing notably the redundant information to verify the integrity of the stream received and optionally to correct it.

FIG. 6 is a block diagram of a system according to the invention comprising a video coder 20 suitable for implementing the steps described with FIG. 5.

In FIG. 6 is represented solely the video sender part 20 for transmitting a stream of compressed images on an unreliable link. The sender comprises a video coder 21 receiving the video stream F and suitable for determining the various areas Z1i belonging to the foreground plane P1 and other areas Z2i belonging to the background plane P2 of a video image, at least one channel coder 22 suitable for adding redundancy according to the method described in FIG. 5, a processing unit 23 suitable for controlling each channel coder in the case where the device possesses several coders and for determining the apportionment of the redundancy to be added, and finally a communication module 24 allowing the system to transmit both the compressed video stream and also the redundancy NALs calculated in a stream designated Fc.

Without departing from the scope of the invention, other techniques exhibiting characteristics similar to Reed-Solomon coding may be used. Thus, to add redundancy, it is possible to implement a coding of particular type such as turbo-codes, convolutional codes, etc.

The method and the system according to the invention exhibit notably the following advantages: using analysis in the compressed domain makes it possible, without needing to decompress the video streams or sequences, to determine the areas that a user desires to protect against transmission errors, the possible loss of information on the non-mobile or practically stationary part having no real consequence on the reading and/or the interpretation of the sequence. In fact, the transmission throughput will be lower than that customarily obtained when redundancy is added to all the images.

1. A method for protecting a compressed video stream, that may be at least decomposed into a first set composed of objects of a first type and a second set composed of objects of a second type, against errors during the transmission of this stream on an unreliable link, characterized in that it comprises at least the following steps:
a) analyzing the stream in the compressed domain (11, 12) so as to define various image areas in which redundancy will be added, the motion estimation vectors and the transformed coefficients obtained in the compressed domain are transmitted to the redundancy addition step,
b) adding redundancy (13a, 13b, 14) to the objects of said areas determined in the previous step, a), while taking account of the motion estimation vectors and of the transformed coefficients obtained in the compressed domain,
c) transmitting the set of areas forming the image.

2. The method for protecting a video stream as claimed in claim 1 for a stream compressed with an H.264 standard, characterized in that it comprises in the course of the redundancy addition step at least the following steps:
analyzing the video stream in the compressed domain (2),
defining (2, 3) at least one first group of objects containing areas of objects or objects to be protected in said stream,
determining, for a given image or a given group of images, a network transport unit of undefined NAL type, which will convey the redundancy information,
an image being composed of several blocks, analyzing the blocks of said image or of the group of images in progress,
i. if the block of the image or of the group of images belongs to the first group, then determining the redundancy data and adding them accompanied by the coordinates of the block of the image in the NAL unit determined in the previous step,
ii. otherwise doing nothing,
transmitting the part of the compressed stream comprising the whole set of original information without particular robustness, as well as the new NAL units transporting the redundancy corresponding to the first group of objects here.

3. The method as claimed in claim 2, characterized in that the first type of object corresponds to a foreground plane comprising mobile objects in an image.

4. The method as claimed in claim 2, characterized in that to calculate the redundancy it uses a Reed Solomon code.

5. The method as claimed in claim 2 or 3, characterized in that it uses a function suitable for determining a mask for the identification of the blocks of an image or group of images comprising one or more mobile objects defined as one or more regions of the mask and the other blocks belonging to the background plane subsequent to an analysis in the compressed domain.

6. The method as claimed in claim 5, characterized in that it uses a function determining the coordinates of encompassing boxes, corresponding to the objects belonging to the foreground plane in an image, the coordinates of said encompassing boxes being determined on the basis of the mask obtained subsequent to the analysis in the compressed domain.

7. A system making it possible to protect a video sequence intended to be transmitted on a very unreliable transmission link, characterized in that it comprises at least one video coder suitable for executing the steps of the method as claimed in one of claims 1 to 6 comprising a video sender (24) and an associated processing unit (22, 23).
